(19) United States
(12) Patent Application Publication
(10) Pub. No.: US 2023/0373143 A1
(43) Pub. Date: Nov. 23, 2023

(54) Plasticizing Device, Injection Molding Device, And Three-Dimensional Modeling Device

(71) Applicant: SEIKO EPSON CORPORATION, Tokyo (JP)

(72) Inventors: Masato NIUYAMA, Matsumoto (JP); Atsuhiko SUGITA, Suwa (JP)

(21) Appl. No.: 18/320,448

(22) Filed: May 19, 2023

(30) Foreign Application Priority Data
May 20, 2022 (JP) 2022-082846

(51) Int. Cl. B29C 45/46; B29C 45/74; B29C 45/18; B29C 45/76

(52) U.S. Cl. CPC B29C 45/464; B29C 45/74; B29C 45/1866; B29C 45/76; B29C 2945/76083; B29C 2945/76354; B29C 2945/76545; B29C 2945/76809; B29C 2945/76832

(57) ABSTRACT

A plasticizing device includes a rotor which has a groove forming surface provided with a groove, which rotates centering on a rotational axis, and a side surface of which is provided with a supply port communicated with the groove, a barrel which has an opposed surface opposed to the groove forming surface in a direction in which the rotational axis extends, and which is provided with a communication hole from which a material plasticized outflows, a heating unit configured to heat the material supplied via the supply port, and a housing configured to house the rotor, wherein the housing is provided with a first supply path and a second supply path configured to supply the material to the supply port.

The present application is based on, and claims priority from JP Application Serial Number 2022-082846, filed May 20, 2022, the disclosure of which is hereby incorporated by reference herein in its entirety.

### BACKGROUND

### 1. Technical Field

The present disclosure relates to a plasticizing device, and an injection molding device equipped with the plasticizing device, and a three-dimensional modeling device.

### 2. Related Art

There is proposed an injection molding machine in which a conventional screw is replaced with a rotor for reducing the size of the injection molding machine. For example, in JP-A-2010-241016 (Document 1), there is disclosed a plasticizing feed device equipped with a rotor provided with a spiral groove, and a barrel which has contact with an end surface of the rotor, and which has a communication hole at the center thereof. According to Document 1, resin which forms a pellet-like shape is retained in a hopper attached to a casing, and is supplied to an outer end portion in a radial direction of the spiral groove of the rotor from the hopper via the casing.

However, in the plasticizing feed device in Document 1, there is a problem that it is difficult to obtain a homogeneously plasticized state. In particular, since there is adopted a configuration in which a material is supplied only when a supply port in an outer circumferential edge of the spiral groove and an input port communicating with the hopper overlap each other in one revolution of the rotor, a feed amount of the melted material decreases until the material is supplied next time, and the material density inside the groove becomes inhomogeneous. Further, in the plasticizing feed device, there is also a problem that it is difficult to switch the material in the middle of the plasticization, or change a ratio between the materials.

### SUMMARY

The present disclosure has an advantage of providing a solution to at least a part of the problem described above, and can be realized as the following application examples or aspects.

### Application Examples

A plasticizing device according to an aspect of the present application includes a rotor which has a groove forming surface provided with a groove, which rotates centering on a rotational axis, and a side surface of which is provided with a supply port communicated with the groove, a barrel which has an opposed surface opposed to the groove forming surface in a direction in which the rotational axis extends, and which is provided with a communication hole from which a material plasticized outflows, a heating unit configured to heat the material supplied via the supply port, and a housing configured to house the rotor, wherein the housing is provided with a first supply path and a second supply path configured to supply the material to the supply port.

An injection molding device according to an aspect of the present application includes the plasticizing device described above, a nozzle section configured to emit the material plasticized by the plasticizing device, and a fixation part configured to fix a molding tool which receives the material.

A three-dimensional modeling device according to an aspect of the present application includes the plasticizing device described above, a nozzle section configured to eject the material plasticized by the plasticizing device, and a stage having a modeling surface on which the material is stacked.

### BRIEF DESCRIPTION OF THE DRAWINGS

FIG. 1 is a perspective view of an injection molding device according to Embodiment 1.

FIG. 2 is a cross-sectional view along a b-b cross-section in FIG. 1.

FIG. 3 is a perspective view in one aspect of a rotor.

FIG. 4 is a plan view in one aspect of the rotor.

FIG. 5 is a plan view in one aspect of the rotor.

FIG. 6 is a plan view of a barrel.

FIG. 7 is a plan view of a case body.

FIG. 8 is a perspective view of a plasticizing device according to Embodiment 2.

FIG. 9 is a plan view of a case body.

FIG. 10 is a plan view of a case body according to Embodiment 3.

FIG. 11 is a plan view of a case body according to Embodiment 4.

FIG. 12 is a plan view of a case body according to Embodiment 5.

FIG. 13 is an enlarged view of the part d in FIG. 2 according to a sixth embodiment.

FIG. 14 is an enlarged view of the part j in FIG. 13.

FIG. 15 is a schematic configuration diagram of a three-dimensional modeling device according to Embodiment 7.

### DESCRIPTION OF EXEMPLARY EMBODIMENTS

### Embodiment 1

### ***General Outline of Injection Molding Device***

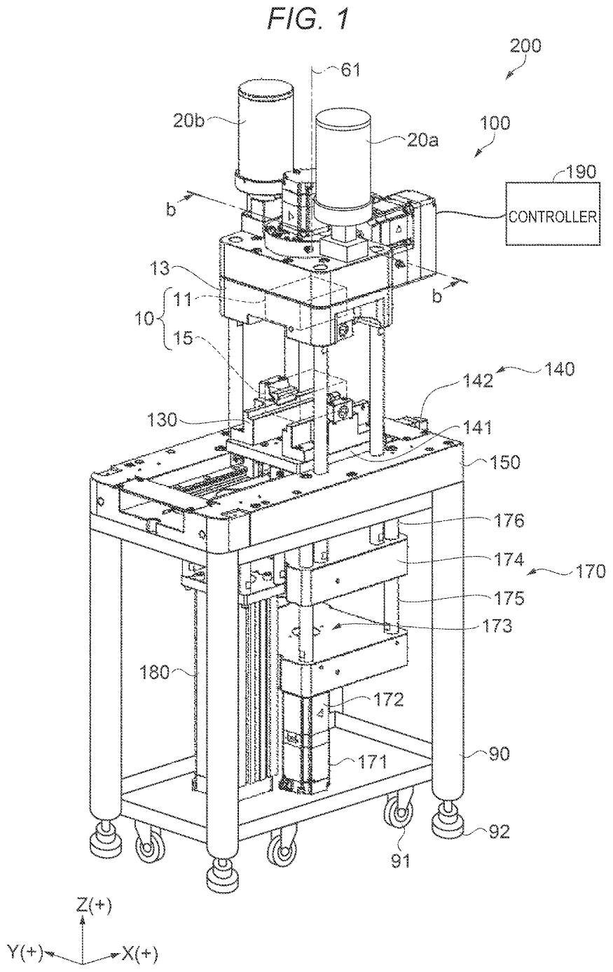

FIG. 1 is a perspective view of an injection molding device.

Some embodiments of the present disclosure will be described with reference to the drawings.

The injection molding device 200 according to the present embodiment shown in FIG. 1 is a vertical injection molding device in which a platform 150 including a plasticizing device 100 is mounted on a pedestal 90 as a movable part. The platform 150 is a base member having a rectangular shape, and is fixed to the pedestal 90. It should be noted that in each of the drawings, there are illustrated an X axis, a Y axis, and a Z axis as three axes perpendicular to each other. An extending direction of long sides in the platform 150 is defined as a positive X direction, and an extending direction of short sides is defined as a positive Y direction. A height direction of the injection molding device 200 is defined as a positive Z direction. The positive Z direction is also referred to as an upper side, and the negative Z direction is also referred to as a lower side.

The injection molding device 200 is constituted by the pedestal 90, the plasticizing device 100, a lower mold support 130, a position changer 140, a mold clamping device 170, an ejector 180, a controller 190, and so on.

The pedestal 90 is a robust pedestal provided with a metal frame, and is provided with wheels 91 on the four corners of a bottom surface of the pedestal. Further, a post in the vicinity of each of the wheels 91 is provided with a bolt-type stopper leg 92. Thus, after moving the injection molding device 200 to a desired position with the wheels 91, it is possible to firmly fix the injection molding device 200 using the stopper legs 92.

Below the plasticizing device 100, there is disposed an upper mold support 13. The upper mold support 13 is provided with a clamp mechanism for fixing an upper mold 11.

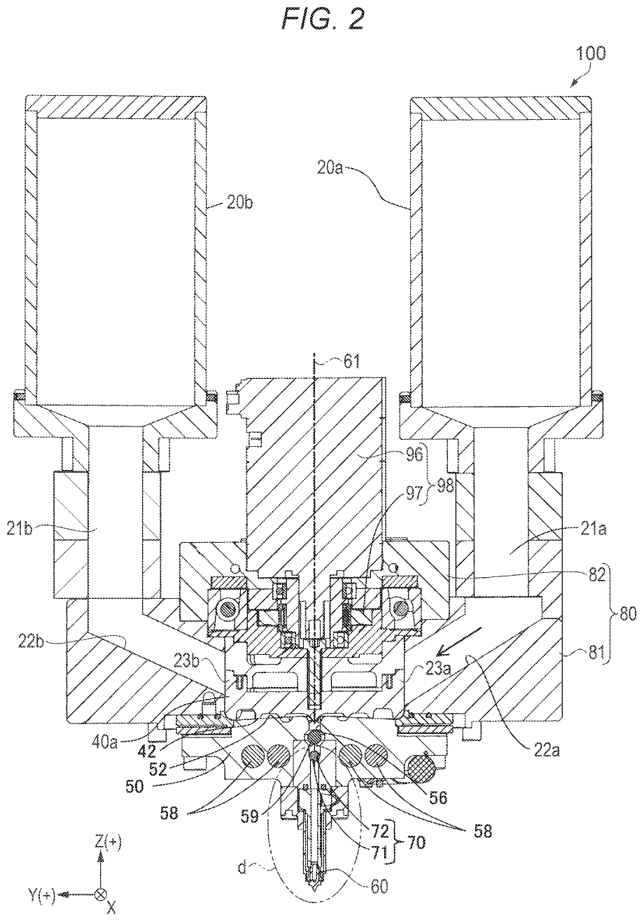

The lower mold support 130 is disposed on the platform 150 via a movable part 141, and is provided with a clamp mechanism for fixing a lower mold 15. In FIG. 1, since the state in which the upper mold 11 and the lower mold 15 have not been attached is shown, the both molds are illustrated as a state of being separated from each other with dotted lines, but when performing the mold injection, the molding is performed in a state in which the upper mold 11 and the lower mold 15 are clamped by the mold clamping device 170. It should be noted that a set of metal molds constituted by the upper mold 11 and the lower mold 15 are referred to as a molding tool 10. Further, the upper mold support 13 and the lower mold support 130 correspond to a fixation part. In other words, the injection molding device 200 is provided with the plasticizing device 100, a nozzle section 60 (FIG. 2) for injecting a material plasticized by the plasticizing device 100, and the upper mold support 13 and the lower mold support 130 as the fixation part for fixing the molding tool 10 which receives the material.

The position changer 140 is a stage which can linearly move the lower mold support 130 along an extending direction of the X axis. The position changer 140 has the movable part 141 for supporting the lower mold support 130, and an electric actuator 142 for moving the movable part 141. In a preferred example, the electric actuator 142 is constituted by a ball screw, a motor for rotating the ball screw, and so on.

The mold clamping device 170 performs mold clamping and mold opening of the molding tool 10 by moving the plasticizing device 100 including the upper mold 11 along the Z-axis direction using the drive of a mold clamping motor 171. In particular, by the driving force of the mold clamping motor 171 being transmitted to a ball screw part 173 via a reduction gear 172, a movable board 174 coupled to the ball screw part 173 moves in the Z direction along a first post part 175 to move the plasticizing device 100 fixed to the movable board 174 via a second post part 176 in the Z direction.

Thus, when performing the mold clamping, by moving the movable board 174 in the negative Z direction, the plasticizing device 100 moves downward, and the upper mold 11 and the lower mold 15 have contact with each other. When performing the mold opening, by moving the movable board 174 toward the positive Z direction, the plasticizing device 100 moves upward, and the upper mold 11 is separated from the lower mold 15.

The ejector 180 is a region for detaching a molded article from the lower mold 15. The ejector 180 is disposed at the negative X side of the plasticizing device 100, and when the lower mold support 130 on which the lower mold 15 after performing molding is mounted moves to an area above the ejector 180, the ejector 180 drives an ejector pin to take out the molded article from the lower mold 15. The ejector 180 is disposed below the platform 150.

The controller 190 is formed of a computer provided with at least one processor, a storage, and an input/output interface for performing input/output of a signal with the outside. In the storage, there are stored a molding program which defines a procedure and a content related to the mold opening, the mold clamping, the mold injection, and the taking out of the molded article, a material adjustment program for adjusting the switching of the material and a combination ratio, associated data, and so on. The controller 190 executes these programs to thereby perform overall control on the whole of the injection molding device 200 including the plasticizing device 100.

### ***Configuration of Plasticizing Device***

FIG. 2 is a cross-sectional view of the plasticizing device in a b-b cross-section in FIG. 1.

As shown in FIG. 2, the plasticizing device 100 is constituted by material reservoirs 20a, 20b, a rotor 40a, a barrel 50, heaters 58, the nozzle section 60, an injection control mechanism 70, and so on.

The plasticizing device 100 plasticizes the material supplied between the rotor 40a and the barrel 50 from the material reservoirs 20a, 20b using the rotor 40a, the barrel 50, and the heaters 58 to generate a molding material, and then injects the molding material from the nozzle section 60 into the molding tool 10 (FIG. 1). It should be noted that in FIG. 2, a rotational axis of the rotor 40a is defined as a center line 61. Further, the term “plasticization” is a concept including melting, and means changing a state of a solid substance into a state having fluidity. Specifically, in the case of a material in which glass transition occurs, the plasticization means that the temperature of the material is made equal to or higher than the glass-transition point. In the case of a material in which the glass transition does not occur, the plasticization means that the temperature of the material is made equal to or higher than the melting point.

The material reservoir 20a is a hopper, and houses a material in the form of a pellet, a powder, or the like. In the present embodiment, there are disposed two material reservoirs, namely the material reservoir 20a and the material reservoir 20b. It should be noted that the material reservoir 20a corresponds to a first material reservoir, and the material reservoir 20b corresponds to a second material reservoir. The material reservoir 20b is disposed at a position where the material reservoir 20b is symmetrical with the material reservoir 20a using the center line 61 as an axis of symmetry. From a planar point of view, the material reservoir 20b is arranged at a position where the material reservoir 20a is rotated as much as 180° taking the center line 61 as a center point (FIG. 1).

Below the material reservoir 20a, there is disposed a pipe part 21a. The pipe part 21a is coupled to a first supply path 22a provided to a case body 81. Similarly, below the material reservoir 20b, there is disposed a pipe part 21b. The pipe part 21b is coupled to a second supply path 22b provided to the case body 81. In other words, the material reservoir 20a as the first material reservoir is communicated with the first supply path 22a, and the material reservoir 20b as the second material reservoir is communicated with the second supply path 22b.

The material of the material reservoir 20a passes through the first supply path 22a, and is supplied between the rotor 40a and the barrel 50 from the input port 23a. Similarly, the material of the material reservoir 20b passes through the second supply path 22b, and is supplied between the rotor 40a and the barrel 50 from the input port 23b.

The rotor 40a is also called a scroll or a flat screw. The rotor 40a is rotationally driven by a rotor driver 98 constituted by a drive motor 96 and a rotor reduction gear 97, taking the center line 61 along the Z-axis direction as a rotational axis. The rotation of the rotor 40a by the rotor driver 98 is controlled by the controller 190.

The rotor 40a and the rotor reduction gear 97 are housed in a housing 80. The housing 80 has a case body 81 and an upper cover 82.

The case body 81 is a member for housing the rotor 40a and the rotor reduction gear 97 so as to surround the rotor 40a and the rotor reduction gear 97 in a horizontal direction. The upper cover 82 is a member which is arranged above the case body 81 so as to cover the rotor 40a and the rotor reduction gear 97 from above.

The drive motor 96 is arranged above the upper cover 82 in a state in which an output shaft of the drive motor 96 coincides with the center line 61.

At the center of the barrel 50, there is formed a communication hole 56 into which the molding material thus generated flows. To the communication hole 56, there is coupled an injection cylinder 71 of the injection control mechanism 70 described later. The communication hole 56 is provided with a check valve 59 disposed upstream of the injection cylinder 71.

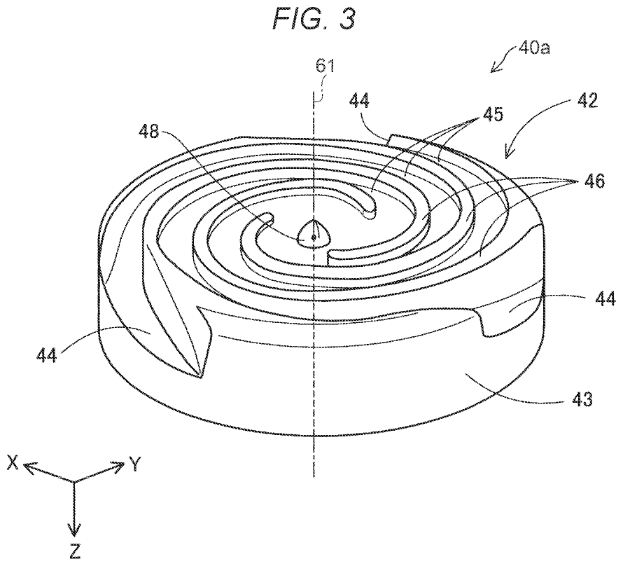

The heaters 58 are each a heating unit, and heat a material supplied between a groove forming surface 42 of the rotor 40a and an opposed surface 52 of the barrel 50. As shown in FIG. 2, in the present embodiment, four heaters 58 are disposed in the barrel 50. The output of the heaters 58 is controlled by the controller 190. In other words, the heaters 58 heat the material supplied via supply ports 44 (FIG. 3) of the rotor 40a.

The injection control mechanism 70 is constituted by the injection cylinder 71, a plunger 72, and so on. The injection control mechanism 70 has a function of injecting the molding material located in the injection cylinder 71 into a cavity of the molding tool 10 (FIG. 1). The injection control mechanism 70 controls an injection amount of the molding material from the nozzle section 60 under the control by the controller 190.

The injection cylinder 71 is a member having a substantially cylindrical shape coupled to the communication hole 56 of the barrel 50, and is arranged in a depth direction (the X-axis direction) in FIG. 2. The plunger 72 is a rod-like member to be inserted into the injection cylinder 71, slides inside the injection cylinder 71, and pressure-feeds the molding material to the nozzle section 60.

### ***Configuration of Rotor***

FIG. 3 is a perspective view showing a schematic configuration of the rotor.

As shown in FIG. 3, the rotor 40a is a disk-like member provided with a spiral groove on a surface thereof. In the rotor 40a, a surface opposed to the barrel 50 (FIG. 2) is referred to as the groove forming surface 42.

On the groove forming surface 42, there are disposed three spiral grooves 45 centering on the center line 61. The grooves 45 revolve from the vicinity of the center line 61 to form spirals, and are communicated with the supply ports 44 provided to a side surface 43 of the rotor 40a. The three grooves 45 are partitioned by three protruding lines 46 as sidewalls. In other words, the rotor 40a has the groove forming surface 42 provided with the grooves 45, rotates centering on the center line 61 as the rotational axis, and the side surface 43 thereof is provided with the supply ports 44 communicated with the respective grooves 45.

From a planar point of view, the three supply ports 44 in the respective three grooves 45 are disposed at positions at intervals of 120 degrees centering on the center line 61 on the side surface 43 of the rotor 40a.

Further, in a central portion of the rotor 40a, there is disposed a retention prevention part 48 as a conically-shaped protruding part. The central axis of the retention prevention part 48 substantially coincides with the center line 61. The tip of the retention prevention part 48 is inserted into the communication hole 56 provided to the barrel 50 (FIG. 2). It is possible to guide the molding material to the communication hole 56 efficiently due to the retention prevention part 48.

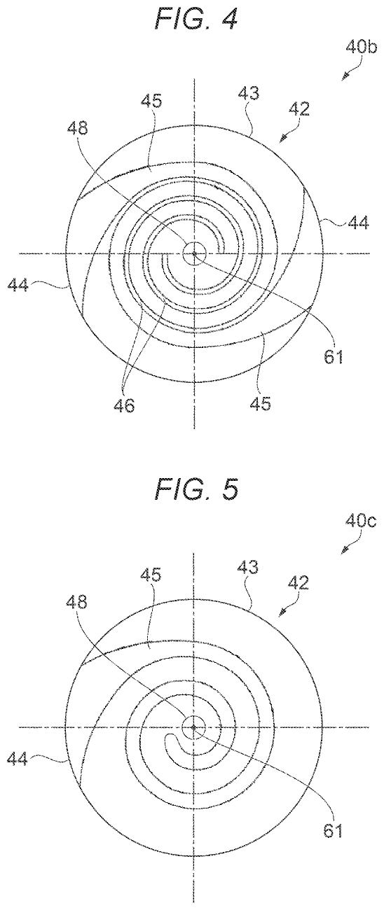

FIG. 4 and FIG. 5 are each a plan view showing a schematic configuration of a rotor according to a different aspect.

In the above description, there is presented an explanation assuming that the rotor 40a has the three grooves 45, it is sufficient to dispose one or more grooves 45, and the number of grooves 45 disposed can be, for example, two, or four or more. Hereinafter, the same regions as those described above are denoted by the same reference numerals, and redundant descriptions will be omitted.

In the rotor 40b shown in FIG. 4, there are disposed two spiral grooves 45 centering on the center line 61 on the groove forming surface 42. The two supply ports 44 in the respective two grooves 45 are disposed at positions opposite to each other centering on the center line 61 on the side surface 43 of the rotor 40b. In other words, one of the supply ports 44 and the other of the supply ports 44 are disposed at positions rotated as much as 180 degrees centering on the center line 61 on the side surface 43 of the rotor 40b.

Further, in the rotor 40c shown in FIG. 5, there is disposed a single spiral groove 45 centering on the center line 61 on the groove forming surface 42. The supply port 44 of the groove 45 is disposed at just one place on the side surface 43 of the rotor 40c.

### ***Configuration of Barrel***

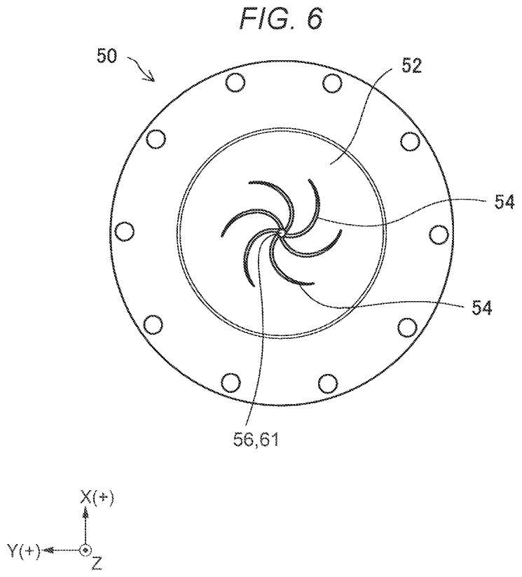

FIG. 6 is a plan view showing a schematic configuration of the barrel.

As shown in FIG. 6, the barrel 50 forms a substantially circular shape, and has the opposed surface 52 opposed to the groove forming surface 42 of the rotor 40a. At the center of the barrel 50, there is disposed the communication hole 56. The center of the communication hole 56 substantially coincides with the center line 61.

On the opposed surface 52, there is disposed a plurality of guide grooves 54 extending to form a spiral shape from the communication hole 56 toward the outer circumference. Although the six guide grooves 54 are disposed in FIG. 6, this is not a limitation, and it is sufficient to dispose two or more guide grooves 54. In other words, the barrel 50 has the opposed surface 52 opposed to the groove forming surface 42 in a direction in which the center line 61 as the rotational axis extends, and is provided with the communication hole 56 through which the plasticized material is made to outflow to the outside. It should be noted that one ends of the guide grooves 54 are not required to be coupled to the communication hole 56. Further, it is not required to provide the guide grooves 54 to the barrel 50.

### ***Configuration of Case Body***

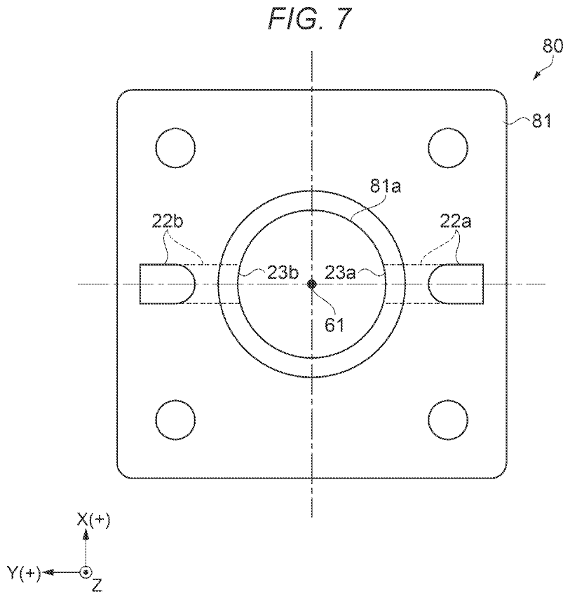

FIG. 7 is a plan view showing a schematic configuration of the case body.

As shown in FIG. 7, at a substantial center of the case body 81 of the housing 80, there is disposed an opening part 81a having a circular shape in which the rotor 40a is housed. On a side surface in the negative Y direction of the opening part 81a, there is disposed the input port 23a, and the input port 23a is communicated with the first supply path 22a. Similarly, on a side surface in the positive Y direction of the opening part 81a, there is disposed the input port 23b, and the input port 23b is communicated with the second supply path 22b. In other words, the case body 81 of the housing 80 is provided with the first supply path 22a and the second supply path 22b capable of supplying the material to the supply ports 44 (FIG. 3) of the rotor 40a.

The input port 23b is disposed at a position where the input port 23b is rotated as much as 180 degrees from the input port 23a centering on the center line 61. In other words, the input port 23a and the input port 23b are arranged so as to be opposed to each other via the opening part 81a.

When the rotor 40a is set on the opening part 81a of such a case body 81, the supply ports 44 of the rotor 40a are opposed to the input port 23a and the input port 23b while the rotor 40a makes one revolution. In other words, it results in that the material is supplied to the supply port 44 of one of the grooves 45 of the rotor 40a from the first supply path 22a and the second supply path 22b while the rotor 40a makes one revolution. Thus, since the material feed is performed twice in one revolution according to the plasticizing device 100 in the present embodiment unlike the conventional plasticizing feed device in which the supply port and the input port overlap each other just once in one revolution of the rotor, it is possible to homogenize the material density in the inside of the rotor 40a.

This applies to the rotor 40b having the two grooves 45 and the rotor 40c having a single groove 45, and it results in that the material feed is performed twice in one revolution on each groove 45. It should be noted that since the larger the number of the grooves 45 is, the more the amount of the material to be introduced increases, it is possible to stably supply the material in a homogeneously plasticized state.

Going back to FIG. 2, the material supplied to the grooves 45 of the rotor 40a is guided to a central portion of the rotor 40a due to the rotation of the rotor 40a while being plasticized between the groove forming surface 42 of the rotor 40a and the opposed surface 52 of the barrel 50 due to the rotation of the rotor 40a and the heating by the heaters 58. The material flowing into the central portion is fed to the communication hole 56 disposed at the center of the barrel 50, and is further guided from the communication hole 56 to the injection control mechanism 70.

As described hereinabove, according to the plasticizing device 100 and the injection molding device 200 in the present embodiment, the following advantages can be obtained.

The plasticizing device 100 is provided with the rotor 40a which has the groove forming surface 42 provided with the grooves 45, which rotates centering on the center line 61 as the rotational axis, and which is provided with the supply ports 44 communicated with the grooves 45 formed on the side surface 43, the barrel 50 which has the opposed surface 52 opposed to the groove forming surface 42 in a direction in which the center line 61 extends, and which is provided with the communication hole 56 for making the plasticized material outflow to the outside, the heaters 58 as the heating units for heating the material supplied via the supply ports 44, and the housing 80 for housing the rotor 40a, and the case body 81 of the housing 80 is provided with the first supply path 22a and the second supply path 22b which are capable of supplying the material to the supply ports 44.

According to the above, since the case body 81 is provided with the first supply path 22a and the second supply path 22b, it results in that the material is supplied from the first supply path 22a and the second supply path 22b to the supply port 44 of the one groove 45 of the rotor 40a while the rotor 40a makes one revolution, in other words, the material feed is performed twice in one revolution.

Therefore, since the material feed is performed twice in one revolution according to the plasticizing device 100 in the present embodiment unlike the conventional plasticizing feed device in which the supply port and the input port overlap each other just once in one revolution of the rotor, it is possible to homogenize the material density in the inside of the rotor 40a. Further, since the rotor 40a has the three grooves 45, it is possible to stably supply the material in the homogeneously plasticized state.

Therefore, it is possible to provide the plasticizing device 100 capable of stably supplying the material in a homogeneously plasticized state.

The injection molding device 200 is provided with the plasticizing device 100, the nozzle section 60 for injecting the material plasticized by the plasticizing device 100, and the upper mold support 13 and the lower mold support 130 as the fixation part for fixing the molding tool 10 which receives the material.

According to the above, the injection molding device 200 is provided with the plasticizing device 100, and is therefore, capable of efficiently performing the injection molding using the material in the homogeneously plasticized state which is stably supplied.

Therefore, it is possible to provide the injection molding device 200 which is high in molding efficiency and is excellent in stability.

### Embodiment 2

### ***Different Aspect-1 of Plasticizing Device***

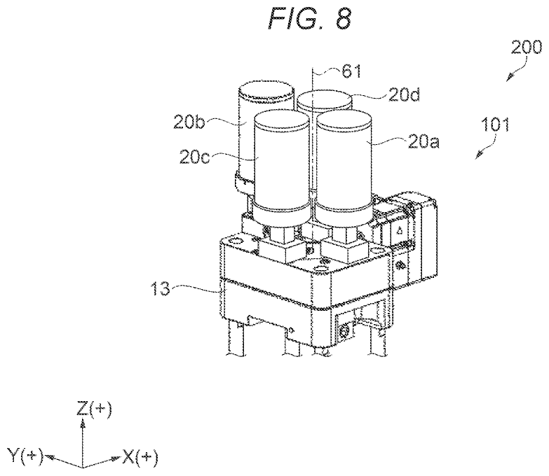

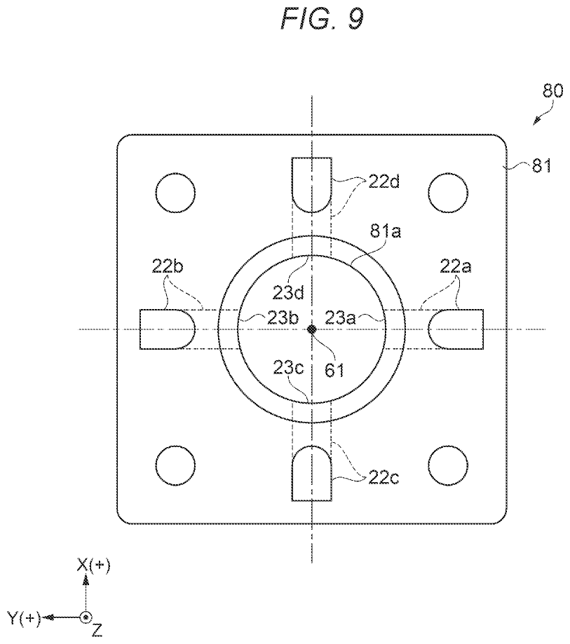

FIG. 8 is a perspective view of a plasticizing device according to Embodiment 2, and corresponds to FIG. 1. FIG. 9 is a plan view showing a schematic configuration of the case body, and corresponds to FIG. 7.

In the embodiment described above, there is presented the description assuming that the case body 81 is provided with two supply paths, namely the first supply path 22a and the second supply path 22b, but this configuration is not a limitation, and it is sufficient to dispose a plurality of supply paths. For example, in a plasticizing device 101 in the present embodiment, there are provided four material reservoirs, and the case body 81 is provided with four supply paths. Hereinafter, the same regions as those in the embodiment described above are denoted by the same reference numerals, and redundant descriptions will be omitted.

As shown in FIG. 8, the plasticizing device 101 in the present embodiment is provided with a material reservoir 20c and a material reservoir 20d in addition to the material reservoirs 20a, 20b described above. From a planar point of view, the material reservoir 20a, the material reservoir 20c, the material reservoir 20b, and the material reservoir 20d are arranged at intervals of 90 degrees taking the center line 61 as a center point.

Below the material reservoir 20c, there is disposed a pipe part similarly to the material reservoir 20a, and the pipe part is coupled to a third supply path 22c provided to the case body 81. Similarly, below the material reservoir 20d, there is disposed a pipe part, and the pipe part is coupled to a fourth supply path 22d provided to the case body 81.

As shown in FIG. 9, the opening part 81a of the case body 81 is provided with the input port 23a, an input port 23c, the input port 23b, and an input port 23d at intervals of 90 degrees centering on the center line 61. It should be noted that the input port 23c is an opening part at a terminal of the third supply path 22c, and the input port 23d is an opening part of a terminal of the fourth supply path 22d.

When the rotor 40a is set on the opening part 81a of such a case body 81, the supply ports 44 of the rotor 40a are opposed to the input port 23a, the input port 23c, the input port 23b, and the input port 23d while the rotor 40a makes one revolution. In other words, it results in that the material is supplied to the supply port 44 of one of the grooves 45 of the rotor 40a from the first supply path 22a, the third supply path 22c, the second supply path 22b, and the fourth supply path 22d while the rotor 40a makes one revolution. Thus, according to the plasticizing device 101 in the present embodiment, since the material feed is performed four times in one revolution, it is possible to homogenizing the material density inside the rotor 40a.

It should be noted that the description is presented above assuming that the four material reservoirs and supply paths are provided at intervals of 90 degrees, but it is sufficient to dispose a plurality of sets thereof, and for example, it is possible to adopt a configuration of providing thee material reservoirs and supply paths at intervals of 120 degrees, and it is possible to adopt a configuration of providing five or more material reservoirs and supply paths.

As described hereinabove, according to the plasticizing device 101 and the injection molding device 200 in the present embodiment, the following advantages can be obtained.

The plasticizing device 101 is provided with the rotor 40a which has the groove forming surface 42 provided with the grooves 45, which rotates centering on the center line 61 as the rotational axis, and which is provided with the supply ports 44 communicated with the grooves 45 formed on the side surface 43, the barrel 50 which has the opposed surface 52 opposed to the groove forming surface 42 in a direction in which the center line 61 extends, and which is provided with the communication hole 56 for making the plasticized material outflow to the outside, the heaters 58 as the heating units for heating the material supplied via the supply ports 44, and the housing 80 for housing the rotor 40a, and the case body 81 of the housing 80 is provided with the first supply path 22a, the third supply path 22c, the second supply path 22b, and the fourth supply path 22d which are capable of supplying the material to the supply ports 44.

According to the above, since the case body 81 is provided with the four supply paths, it results in that the material feed is performed four times in one revolution of the rotor 40a.

Therefore, since the material feed is performed four times in one revolution according to the plasticizing device 101 in the present embodiment unlike the conventional plasticizing feed device in which the supply port and the input port overlap each other just once in one revolution of the rotor, it is possible to homogenize the material density in the inside of the rotor 40a. Further, since the rotor 40a has the three grooves 45, it is possible to stably supply the material in the homogeneously plasticized state.

Therefore, it is possible to provide the plasticizing device 101 capable of stably supplying the material in a homogeneously plasticized state. Thus, it is possible to provide the injection molding device 200 which is high in molding efficiency and is excellent in stability.

### Embodiment 3

### ***Different Aspect-2 of Plasticizing Device***

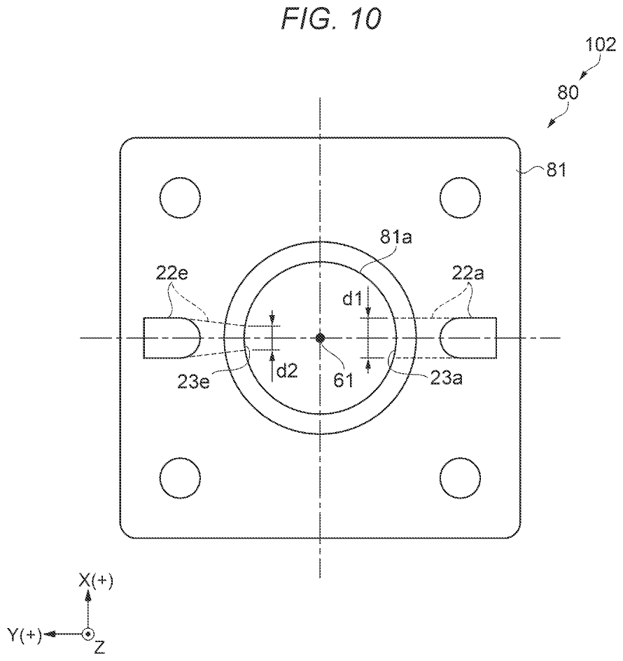

FIG. 10 is a plan view showing a schematic configuration of the case body, and corresponds to FIG. 7.

In Embodiment 1, there is presented the description assuming that the case body 81 is provided with two supply paths, namely the first supply path 22a and the second supply path 22b the same in flow path diameter, but this configuration is not a limitation, and the two supply paths can be different in flow path diameter. For example, in a plasticizing device 102 in the present embodiment, a minimum cross-sectional area in the first supply path 22a and a minimum cross-sectional area in the second supply path 22e are different from each other. Hereinafter, the same regions as those in Embodiment 1 are denoted by the same reference numerals, and redundant descriptions will be omitted.

First, the configuration of the first supply path 22a and the input port 23a is the same as in Embodiment 1.

The second supply path 22e is the same in shape of the opening part on the surface in the case body 81 as the first supply path 22a, but the cross-sectional area of the input port 23e is made smaller than the cross-sectional area of the input port 23a. In particular, as shown in FIG. 10, the second supply path 22e tapers from the opening part on the surface of the case body 81, and becomes the thinnest at the input port 23e. For example, when the input port 23e has a circular shape, the diameter d2 is made smaller than a diameter d1 of the input port 23a. In other words, the minimum cross-sectional area in the first supply path 22a and the minimum cross-sectional area in the second supply path 22e are different from each other. It should be noted that a portion which narrows the flow path diameter is not limited to the input port 23e, and it is sufficient for the second supply path 22e to be narrowed at least at one place.

Thus, regarding an amount of the material to be supplied to the rotor 40a, a feed amount from the second supply path 22e becomes smaller than a feed amount from the first supply path 22a.

Further, in a preferred example, the material retained in the material reservoir 20a and the material retained in the material reservoir 20b are made different from each other. In other words, a first material is retained in the material reservoir 20a, a second material is retained in the material reservoir 20b, and the first material and the second material are made different from each other.

Thus, it is possible to change a supply ratio between the first material and the second material.

As described hereinabove, according to the plasticizing device 102 and the injection molding device 200 in the present embodiment, the following advantages can be obtained.

In the plasticizing device 102, the minimum cross-sectional area in the first supply path 22a and the minimum cross-sectional area in the second supply path 22e are different from each other.

According to the above, by making the first supply path 22a and the second supply path 22e different in flow path diameter from each other, it is possible to change the supply ratio of the material.

Further, in the plasticizing device 102, the first material is retained in the material reservoir 20a, the second material is retained in the material reservoir 20b, and the first material and the second material are made different from each other. According to the above, it is possible to change the supply ratio between the first material and the second material.

### Embodiment 4

### ***Different Aspect-3 of Plasticizing Device***

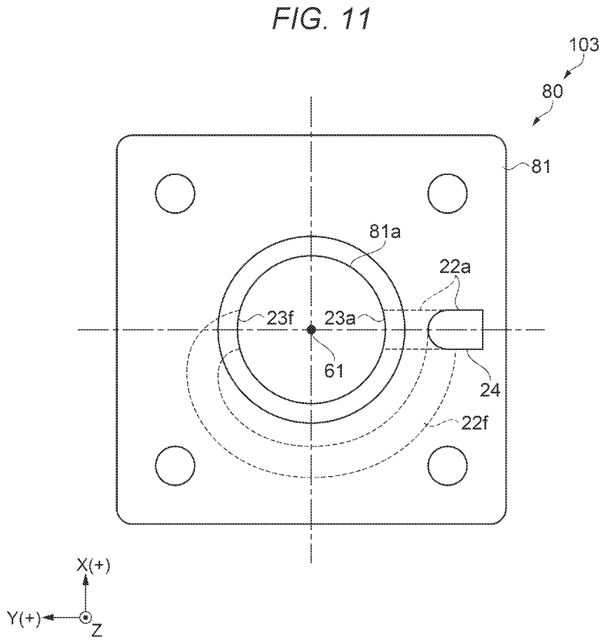

FIG. 11 is a plan view showing a schematic configuration of the case body, and corresponds to FIG. 7.

In Embodiment 1 through Embodiment 3, there is presented the description assuming that there are provided two or more material reservoirs including the material reservoir 20a and the material reservoir 20b, but this configuration is not a limitation, and it is sufficient to provide a plurality of supply paths even when there is just one material reservoir. For example, in a plasticizing device 103 in the present embodiment, there is adopted a configuration in which the material reservoir 20a is provided alone as the material reservoir, but there are two supply paths. Hereinafter, the same regions as those in Embodiment 1 are denoted by the same reference numerals, and redundant descriptions will be omitted.

In the plasticizing device 103 in the present embodiment, there is adopted a configuration in which the material reservoir 20a is provided alone as the material reservoir although not shown in the drawings. Further, as shown in FIG. 11, the case body 81 is provided with just one entrance opening part 24 communicated with the first supply path 22a.

As shown in FIG. 11, the supply path is branched into two paths, namely the first supply path 22a and the second supply path 22f, immediately below the entrance opening part 24. In other words, the supply path is branched into two inside the case body 81. It should be noted that it is sufficient for the supply path to be branched into a plurality of paths, and for example, it is possible for the supply path to be branched into three, or to be branched into four or more. According to the above, it is possible to supply the material from the single material reservoir to the plurality of supply paths.

The first supply path 22a extends straight in the positive Y direction from the entrance opening part 24, and is communicated with the input port 23a in the opening part 81a at the center of the case body 81.

The second supply path 22f extends toward the negative X direction from the entrance opening part 24, and is communicated with the input port 23f along the periphery of the opening part 81a. The input port 23f is disposed at a position opposed to the input port 23a via the opening part 81a. In other words, when defining end portions of the first supply path 22a and the second supply path 22f in the case body 81 of the housing 80 as the input port 23a and the input port 23f, respectively, as one ends, the entrance opening parts 24 as the other ends of the first supply path 22a and the second supply path 22f are directly coupled to each other. It should be noted that the configuration in which the first supply path 22a and the second supply path 22f are directly coupled to each other at the entrance opening parts 24 is not a limitation, and it is possible to adopt a configuration in which, for example, a material pool capable of containing a certain amount of the material is disposed in the vicinity of the entrance opening part 24, and both of the first supply path 22a and the second supply path 22f are indirectly coupled to each other via the material pool.

According to the above, since the case body 81 is provided with the first supply path 22a and the second supply path 22f, the material is supplied from the first supply path 22a and the second supply path 22f to the supply port 44 of the one groove 45 of the rotor 40a while the rotor 40a makes one revolution. In other words, it results in that the material feed is performed twice in one revolution.

Therefore, according to the plasticizing device 103 in the present embodiment, since the material feed is performed twice in one revolution, it is possible to homogenizing the material density inside the rotor 40a.

As described hereinabove, according to the plasticizing device 103 and the injection molding device 200 in the present embodiment, the following advantages can be obtained.

In the plasticizing device 103, when defining end portions of the first supply path 22a and the second supply path 22f in the case body 81 of the housing 80 as the input port 23a and the input port 23f, respectively, as one ends, the entrance opening parts 24 as the other ends of the first supply path 22a and the second supply path 22f are directly coupled to each other.

According to the above, also in the configuration in which the material reservoir 20a is provided alone as the material reservoir, since the case body 81 is provided with the first supply path 22a and the second supply path 22f, the material is supplied from the first supply path 22a and the second supply path 22f to the supply port 44 of the one groove 45 of the rotor 40a while the rotor 40a makes one revolution. In other words, it results in that the material feed is performed twice in one revolution. Further, since the rotor 40a has the three grooves 45, it is possible to stably supply the material in the homogeneously plasticized state.

Therefore, it is possible to provide the plasticizing device 103 capable of stably supplying the material in a homogeneously plasticized state.

### Embodiment 5

### ***Different Aspect-4 of Plasticizing Device***

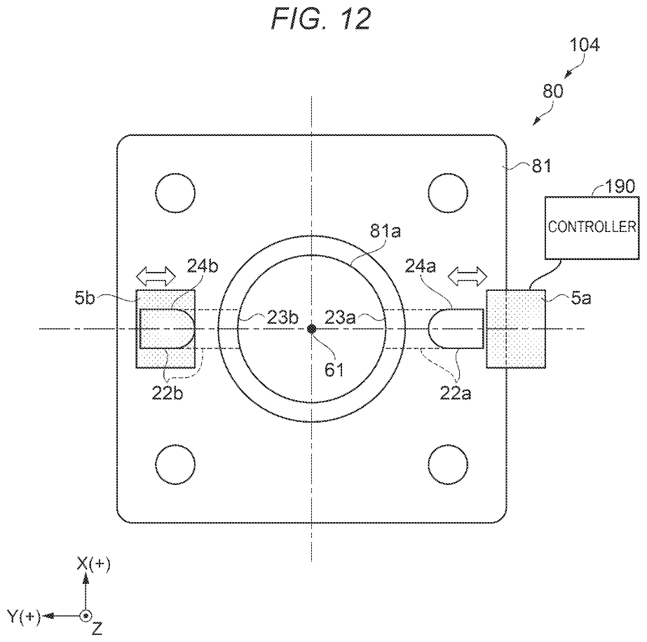

FIG. 12 is a plan view showing a schematic configuration of the case body, and corresponds to FIG. 7.

Although there is described the configuration in which the case body 81 is provided with a plurality of supply paths in the embodiments described above, it is possible to dispose an adjuster for opening/closing the flow path in the supply path. For example, in a plasticizing device 104 in the present embodiment, the first supply path 22a is provided with a first adjuster 5a, and the second supply path 22b is provided with a second adjuster 5b. Hereinafter, the same regions as those in Embodiment 1 are denoted by the same reference numerals, and redundant descriptions will be omitted.

As shown in FIG. 12, in the plasticizing device 104 in the present embodiment, the first supply path 22a is provided with the first adjuster 5a, and the second supply path 22b is provided with the second adjuster 5b. It should be noted that the description in FIG. 7 can be applied except the point that the first adjuster 5a and the second adjuster 5b are disposed.

The first adjuster 5a is a shutter mechanism, and is provided to the entrance opening part 24a of the case body 81. The first adjuster 5a is provided with a linear actuator including a drive motor not shown, and makes the shutter mechanism operate in an arrow direction (an extending direction of the Y axis) in FIG. 12 in accordance with a control signal from the controller 190. The shutter mechanism not only opens/closes fully, but can stop halfway to narrow the flow path diameter. The second adjuster 5b is also the same shutter mechanism as the first adjuster 5a. It should be noted that providing the adjuster to the entrance opening part is not a limitation, and it is sufficient to dispose the adjuster somewhere in the supply path, and it is possible to dispose the adjuster in, for example, the input port. In other words, at least one of the first supply path 22a and the second supply path 22b is provided with the adjuster for adjusting the supply amount of the material.

For example, in FIG. 12, there is shown the state in which the first adjuster 5a of the first supply path 22a fully opens, wherein the whole of the entrance opening part 24a is exposed. On the other hand, there is shown the state in which the second adjuster 5b closes in the second supply path 22b, wherein the whole of the entrance opening part 24b is covered with the second adjuster 5b. In a preferred example, opening/closing of the first adjuster 5a and the second adjuster 5b is performed in accordance with the rotational period of the rotor 40a. In particular, the first adjuster 5a is opened at the timing at which the supply port 44 of the rotor 40a comes to the input port 23a of the first supply path 22a, but is closed otherwise. In other words, there is performed the control so that the first adjuster 5a is selectively opened at the timing at which the supply port 44 of the rotor 40a overlaps the input port 23a of the first supply path 22a. Similarly, the second adjuster 5b is opened at the timing at which the supply port 44 of the rotor 40a comes to the input port 23b of the second supply path 22b, but is closed otherwise. In other words, the controller 190 controls the first adjuster 5a and the second adjuster 5b based on the position of the rotor 40a in the rotational period.

Thus, since the material is not fed when the supply port 44 of the rotor 40a is not located at the position of the input port 23a of the first supply path 22a, it is possible to prevent tucking of the material between the rotor 40a and the barrel 50. In other words, by selectively opening the first adjuster 5a at the timing at which the supply port 44 of the rotor 40a overlaps the input port 23a of the first supply path 22a, it is possible to prevent a material jam. The same applies to the second supply path 22b.

Further, by retaining materials different in color respectively in the material reservoir 20a and the material reservoir 20b, it is also possible to manufacture a molded article with a marble pattern. For example, a red material is retained in the material reservoir 20a, and a white material is retained in the material reservoir 20b in advance. Opening/closing of the first adjuster 5a and the second adjuster 5b is performed in accordance with the rotational period of the rotor 40b using the rotor 40b of a two-line type so that the red material is supplied to one groove and the white material is supplied to the other groove. Thus, it is possible to generate a plasticized material with a white-and-red marble pattern. Further, for example, a recycled material obtained by pelletizing waste materials such as runners generated when performing molding is retained in the material reservoir 20a, and a new material is retained in the material reservoir 20b in advance. By adjusting the opening/closing of the first adjuster 5a and the second adjuster 5b, it is possible to mix the recycled material with the new material at a constant ratio. Thus, it is possible to realize reduction in environmental burden and reduction in material cost.

Further, for example, when narrowing the flow path diameter with the second adjuster 5b, it is possible to make the first supply path 22a and the second supply path 22b different in flow path diameter similarly to the description in FIG. 10, and therefore, it is possible to change the supply ratio between the materials. On this occasion, it is assumed that settings of the first adjuster 5a and the second adjuster 5b are fixed irrespective of the rotation of the rotor 40a.

As described hereinabove, according to the plasticizing device 104 and the injection molding device 200 in the present embodiment, the following advantages can be obtained.

In the plasticizing device 104, at least one of the first supply path 22a and the second supply path 22b is provided with the adjuster for adjusting the supply amount of the material. Further, the controller 190 controls the first adjuster 5a and the second adjuster 5b based on the position of the rotor 40a in the rotational period.

According to the above, since the material is not fed when the supply port 44 of the rotor 40a is not located at the position of the input port 23a of the first supply path 22a, it is possible to prevent tucking of the material between the rotor 40a and the barrel 50. Therefore, by selectively opening the first adjuster 5a at the timing at which the supply port 44 of the rotor 40a overlaps the input port 23a of the first supply path 22a, it is possible to prevent a material jam.

Therefore, it is possible to provide the plasticizing device 104 capable of stably supplying the material in a homogeneously plasticized state. It should be noted that the first adjuster 5a and the second adjuster 5b are not limited to the shutter mechanisms, and it is possible to use other known mechanisms as long as the supply amount of the material can be controlled.

### Embodiment 6

### ***Different Aspect-5 of Plasticizing Device***

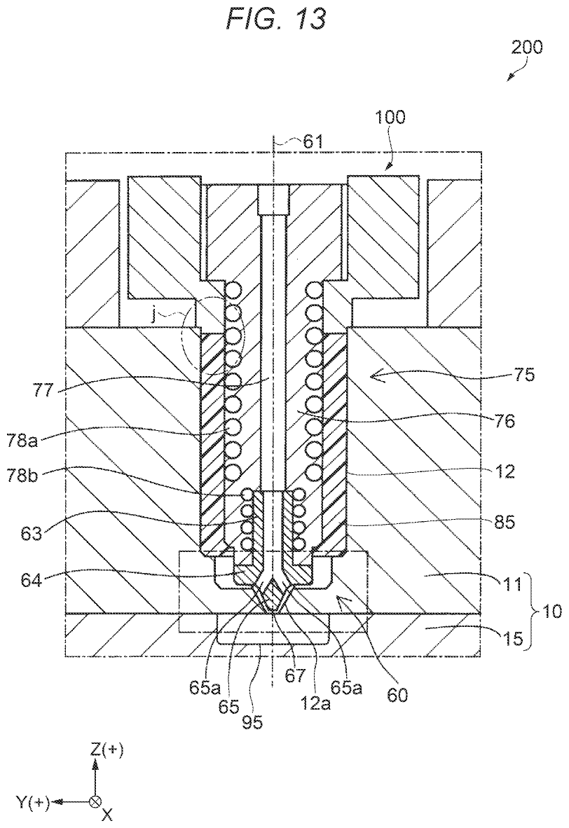

FIG. 13 is an enlarged view of the part d in FIG. 2. It should be noted that in FIG. 13, the molding tool 10 is illustrated.

In each of the embodiments described above, it is possible to dispose a cap member 85 on the periphery of a hot runner 75 in order to enhance easiness in maintenance of the molding tool and so on. Hereinafter, the same regions as those in the embodiment described above are denoted by the same reference numerals, and redundant descriptions will be omitted.

As shown in FIG. 13, the nozzle section 60 of the plasticizing device 100 is arranged immediately above the cavity 95 of the molding tool 10. The molding tool 10 is constituted by the upper mold 11 as a stationary mold and the lower mold 15 as a movable mold having contact with each other. In other words, the molding tool 10 includes the upper mold 11 as the stationary mold and the lower mold 15 as the movable mold.

The upper mold 11 is provided with an attachment hole 12 for the hot runner 75. The attachment hole 12 is formed so that the inner diameter thereof decreases in a stepped manner as a depth from the opening part increases toward the negative Z direction. An end portion 12a in the deepest portion in the attachment hole 12 is formed to have a substantially conical shape with the inner diameter gradually decreasing. The tip of the end portion 12a functions as a gate opening 67 from which the molding material is injected. The gate opening 67 is formed as a substantially circular hole.

The hot runner 75 is arranged in the attachment hole 12 of the upper mold 11, and guides the molding material supplied from the plasticizing device 100 to the gate opening 67 in a heated state.

As shown in FIG. 13, the hot runner 75 is constituted by a main body part 76, the nozzle section 60, heaters 78a, 78b, and so on.

The main body part 76 forms a substantially cylindrical shape, and is provided with an internal thread not shown on an inner circumferential surface of an end portion at the gate opening 67 side.

The nozzle section 60 is constituted by a coupling part 63, a flange part 64, a tip portion 65, and so on.

The coupling part 63 has a substantially cylindrical shape, and on the outer circumferential surface thereof, there is formed an external thread not shown. The external thread and the internal thread of the main body part 76 screw together, and the coupling part 63 (the nozzle section 60) is fixed inside the main body part 76.

The flange part 64 is a flange-like region which has a larger outer diameter than the outer diameter of the coupling part 63.

The tip portion 65 is a substantially conical region protruding toward the gate opening 67 from the flange part 64. The coupling part 63, the flange part 64, and the tip portion 65 are integrally configured.

At the center of the main body part 76 and the nozzle section 60, there is formed a flow path 77. The flow path 77 is disposed along the center line 61, and has a function of guiding the molding material to the gate opening 67.

The flow path 77 is communicated with nozzle openings 65a branched into two in the tip portion 65 of the nozzle section 60. It should be noted that the number of the nozzle openings 65a is not limited to two, but can be three, or it is possible to dispose four or more nozzle openings 65a.

Due to such a structure, when observing the periphery of the nozzle section 60 from the cavity 95 side, there is formed a ring-like shape centering on the tip portion 65. Therefore, the gate opening 67 is formed of an open-gate structure also called a so-called ring gate. In the open-gate structure, the flow path 77 is not closed even when the molding material cures, and there is created a state in which the gate opening 67 always opens.

The heater 78a is a coil heater embedded in the main body part 76, and heats the hot runner 75. The heater 78b is a coil heater surrounding the outer circumference of the coupling part 63 of the nozzle section 60, and heats the nozzle section 60. Due to heating by the heaters 78a, 78b, the molten state of the molding material flowing through the flow path 77 is kept.

### ***Configuration of Cap Member***

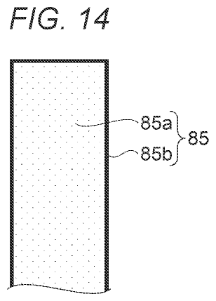

FIG. 14 is an enlarged view of the part j in FIG. 13.

As shown in FIG. 13, the cap member 85 is disposed on the periphery of the hot runner 75. In particular, the cap member 85 is a cap member which surrounds the periphery of the main body part 76 having a cylindrical shape in the hot runner 75, and which has a cylindrical shape one size thicker than the main body part 76. The cavity 95 side of the cap member 85 is formed up to an area before the flange part 64 of the nozzle section 60, and the tip of the cap member 85 opens.

As shown in FIG. 14, the cap member 85 has a core portion 85a located inside, and a shell portion 85b on the surface of the cap member 85. The cap member 85 is formed of a material higher in melting point than the material to be plasticized. In a preferred example, metal is used as a material of the cap member 85.

The core portion 85a has a plurality of voids, and is made higher in void ratio than the shell portion 85b. The shell portion 85b is made harder than the core portion 85a. In other words, the material density of the core portion 85a is low, and the material density of the shell portion 85b is made high.

In the preferred example, the cap member 85 uses a member modeled with the material including metal using a 3D printer. As the metal, stainless steel is preferable. It should be noted that stainless steel is not a limitation, and it is sufficient to be metal having equivalent physicality. In other words, the cap member 85 is formed using a material higher in melting point than the material to be plasticized, and is arranged between the upper mold 11 and the nozzle section 60.

Further, in separately forming the core portion 85a and the shell portion 85b as the surface with a difference in density from each other, it is possible to use, for example, a hollow modeling technology of a 3D printer. In particular, in the modeling program, the 3D modeling is performed while setting the material density so that the material density of the core portion 85a is low and the material density of the shell portion 85b is high.

As described hereinabove, according to the plasticizing device 100 and the injection molding device 200 in the present embodiment, the following advantages can be obtained.

In the injection molding device 200 provided with the plasticizing device 100, the molding tool 10 includes the upper mold 11 as the stationary mold, and the lower mold 15 as the movable mold, and is provided with the cap member 85 which is arranged between the upper mold 11 and the nozzle section 60, and uses the material higher in melting point than the material to be plasticized, and the cap member 85 has the core portion 85a located inside and the shell portion 85b on the surface, and the core portion 85a has the plurality of voids, and is higher in void ratio than the shell portion 85b.

When performing normal molding in which the cap member 85 is not disposed, the periphery of the hot runner 75 in the attachment hole 12 is filled with the material thus plasticized, and that resin plays the role of a cap member or the like. However, since the periphery of the hot runner 75 is always made high in temperature, the resin with which the periphery is filled is apt to be carbonized, and periodic cleaning is required.

In contrast, by disposing the cap member 85 made of metal on the periphery of the hot runner 75, it is possible to dramatically reduce the frequency of the cleaning, and therefore, it is possible to enhance the easiness in maintenance of the molding tool 10. Further, since the core portion 85a is formed to be low in material density, the core portion 85a functions as an air heat-insulating layer, and therefore, it is possible to enhance the heat-insulating property between the hot runner 75 and the upper mold 11. Thus, it is possible to reduce the carbonization of the resin. When the carbonization of the resin is reduced, occurrence of defect such as a black dot in the molded article is also reduced.

Therefore, it is possible to provide the injection molding device 200 which is high in maintenance easiness, high in molding efficiency, and excellent in stability.

### Embodiment 7

### ***Three-Dimensional Modeling Device***

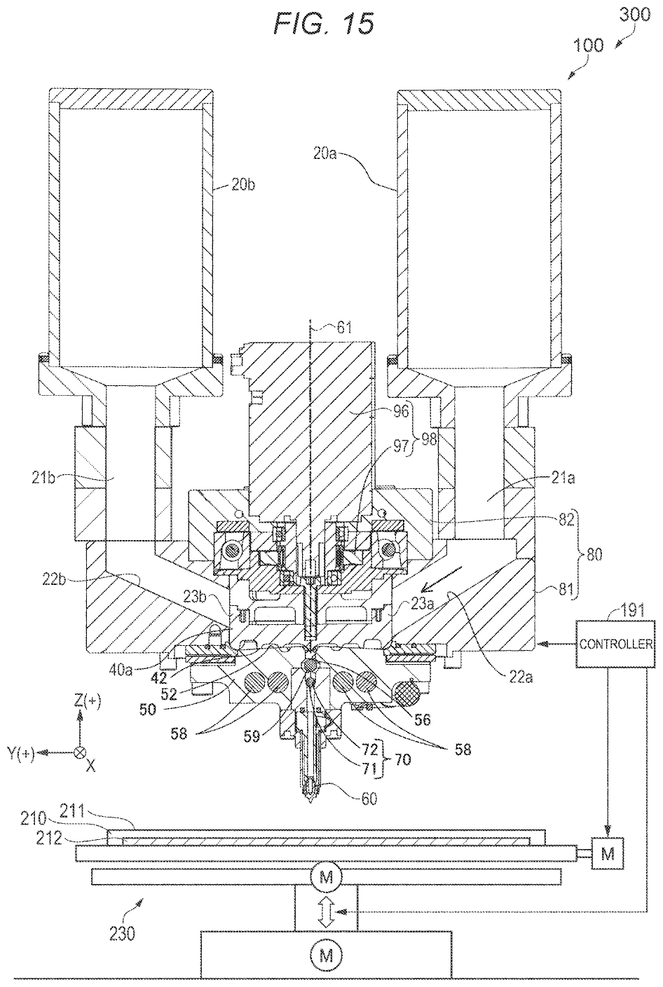

FIG. 15 is a schematic configuration diagram of a three-dimensional modeling device.

The plasticizing devices 100 through 104 in the embodiments described above can be applied also to the three-dimensional modeling device. Hereinafter, the same regions as those in the embodiment described above are denoted by the same reference numerals, and redundant descriptions will be omitted.

The three-dimensional modeling device 300 according to the present embodiment is constituted by the plasticizing device 100 which generates the molding material formed of the plasticized material to eject the molding material, a stage 210 having a modeling surface 211 on which the molding material is stacked, a position changer 230 for changing a relative position between the nozzle section 60 and the stage 210, a controller 191 for controlling the position changer 230, and so on.

The stage 210 is arranged at the position opposed to the nozzle section 60. In the present embodiment, the modeling surface 211 of the stage 210 opposed to the nozzle section 60 is arranged to be parallel to the X, Y directions, namely a horizontal direction. When performing the three-dimensional modeling, the three-dimensional modeling device 300 ejects the molding material from the tip of the nozzle section 60 toward the modeling surface 211 of the stage 210 to stack layers to thereby shape a three-dimensional shaped article. In other words, the three-dimensional modeling device 300 is provided with the plasticizing device 100, the nozzle section 60 for ejecting the material plasticized by the plasticizing device 100, and the stage 210 having the modeling surface 211 on which the material is stacked.

The stage 210 is provided with a stage heater 212 as a heating unit. The stage heater 212 prevents the temperature of the molding material ejected on the stage 210 from rapidly decreasing.

The position changer 230 changes the relative position between the nozzle section 60 and the stage 210. In the present embodiment, the position of the nozzle section 60 is fixed, and the position changer 230 moves the stage 210. The position changer 230 is formed of a triaxial positioner for moving the stage 210 in triaxial directions, namely the X, Y, and Z directions with driving forces of three motors. The position changer 230 changes the relative positional relationship between the nozzle section 60 and the stage 210 under the control by the controller 191. It should be noted that the movement of the nozzle section 60 means that the nozzle section 60 is made to move relatively to the stage 210.

It should be noted that instead of the configuration of moving the stage 210 with the position changer 230, it is possible to adopt a configuration in which the position changer 230 moves the nozzle section 60 relatively to the stage 210 in the state in which the position of the stage 210 is fixed.

Alternatively, it is possible to adopt a configuration of making the position changer 230 move the stage 210 in the Z direction, and move the nozzle section 60 in the X, Y directions, or a configuration of making the position changer 230 move the stage 210 in the X, Y directions, and move the nozzle section 60 in the Z direction. Even when adopting these configurations, the relative positional relationship between the nozzle section 60 and the stage 210 is changeable.

As described hereinabove, according to the three-dimensional modeling device 300 in the present embodiment, the following advantages can be obtained.

The three-dimensional modeling device 300 is provided with the plasticizing device 100, the nozzle section 60 for ejecting the material plasticized by the plasticizing device 100, and the stage 210 having the modeling surface 211 on which the material is stacked.

According to the above, the three-dimensional modeling device 300 is provided with the plasticizing device 100, and is therefore, capable of efficiently performing the 3D modeling using the material in the homogeneously plasticized state which is stably supplied. Therefore, it is possible to provide the three-dimensional modeling device 300 which is high in modeling efficiency and is excellent in stability.

What is claimed is:

1. A plasticizing device comprising:
a rotor which has a groove forming surface provided with a groove, which rotates centering on a rotational axis, and a side surface of which is provided with a supply port communicated with the groove;
a barrel which has an opposed surface opposed to the groove forming surface in a direction in which the rotational axis extends, and which is provided with a communication hole from which a material plasticized outflows;
a heating unit configured to heat the material supplied to the groove via the supply port; and
a housing configured to house the rotor, wherein
the housing is provided with a first supply path and a second supply path configured to supply the material to the supply port.

2. The plasticizing device according to claim 1, further comprising:
a first material reservoir communicated with the first supply path; and
a second material reservoir communicated with the second supply path.

3. The plasticizing device according to claim 2, wherein
a first material is retained in the first material reservoir,
a second material is retained in the second material reservoir, and
the first material and the second material are different from each other.

4. The plasticizing device according to claim 1, wherein
a minimum cross-sectional area of the first supply path and a minimum cross-sectional area of the second supply path are different from each other.

5. The plasticizing device according to claim 1, wherein
when defining an end portion at the supply port side of each of the first supply path and the second supply path as one end, another end in the first supply path and another end in the second supply path are directly or indirectly coupled to each other.

6. The plasticizing device according to claim 1, wherein
at least either one of the first supply path and the second supply path is provided with an adjuster configured to control a supply amount of the material.

7. The plasticizing device according to claim 6, further comprising:
a controller configured to control the adjuster, wherein
the controller is configured to control the adjuster based on a position of the rotor in a rotational period thereof.

8. An injection molding device comprising:
the plasticizing device according to claim 1;
a nozzle section configured to emit the material plasticized by the plasticizing device; and
a fixation part configured to fix a molding tool which receives the material.

9. The injection molding device according to claim 8, further comprising:
a cap member using a material higher in melting point than the material, wherein
the molding tool includes a movable mold and a stationary mold,
the cap member is arranged between the stationary mold and the nozzle section,
the cap member has a core portion located inside, and a shell portion on a surface, and
the core portion has a plurality of voids, and is higher in void ratio than the shell portion.
